(19) United States
(12) Patent Application Publication
(10) Pub. No.: US 2003/0051127 A1
(43) Pub. Date: Mar. 13, 2003

(54) Method of booting electronic apparatus, electronic apparatus and program

(75) Inventor: Yohichi Miwa, Kanagawa-ken (JP)

Correspondence Address: BRACEWELL & PATTERSON, L.L.P., P.O. BOX 969, Austin, TX, 78767-0969, US

(73) Assignee: International Business Machines Corporation, Armonk, NY

(21) Appl. No.: 10/235,017

(22) Filed: Sep. 4, 2002

(30) Foreign Application Priority Data
Sep. 7, 2001 (JP) 2001-272413

(51) Int. Cl. G06F 9/24

(52) U.S. Cl. 713/2

(57) ABSTRACT

A plurality of hard disk drives 102-105, and a timer 107 are provided in a server unit 101. An OS is stored in each of the hard disk drives 102 and 103. First, an attempt is made to load the OS stored in the hard disk drive 102 and, at the same time, counting is started by the timer 107. If the loading of the OS stored in the hard disk drive 102 has not been completed when a count value of the timer 107 has reached a predetermined value, the loading operation is stopped, and the OS stored in the hard disk drive 103 is loaded.

This application claims the priority benefit of Japanese patent application No. 2001-272413, filed on Sep. 7, 2001, and entitled “Method of Booting Electronic Apparatus, Electronic Apparatus and Program.”

### BACKGROUND OF THE INVENTION

I. Technical Field

The present invention relates in general to the field of computers, and, in particular, to the field of computer software. Still more particularly, the present invention relates to a novel method of starting or loading an Operating System (OS), including an OS utilized in the startup of a server unit. The present invention also relates to an electronic apparatus that adopts the novel method of starting or loading an OS, and a program for causing a computer to execute the novel method of starting or loading an OS.

II. Description of the Prior Art

A computer is booted in such a way that an OS stored in a hard disk drive is loaded (into a main memory) in accordance with a startup procedure stored in a Read Only Memory (ROM). Typically, the startup procedure for the OS is included in Basic Input/Output System (BIOS). The OS is software that manages a computer system and provides a basic user operating environment. The BIOS is a group of basic programs for diagnosing, initializing and controlling hard disk drives and input/output interfaces, and the startup procedure for the OS is usually included therein.

A server connected to a network maybe requested to continue stable operations for either a fixed time zone within a day (e.g., from 9:00 to 17:00) or continuously for 24 hours a day. If any problem has occurred during the operation of the server and server has become unable to continue its operation, a reset function automatically restarts the server. Also, the server which operates in the fixed time zone is automatically booted at a predetermined time (for example, at nine o'clock in the morning on each of Monday through Friday).

The hard disk drive may be most liable to fail or break down among components constituting a computer. The reason therefor is that the hard disk drive is a precision machine having rotating and head moving mechanisms for which precise controls are required.

The failure of the hard disk drive causes the booting operation of the server to become impossible. Since the hard disk drive is liable to fail as stated above, it is necessary, in practice, to treat it as failing at a certain probability after it has been used for a certain period. In general, there may arise the situation that the server suddenly stops and becomes unable to restart one day, or cannot start up even at the predetermined time.

Usually, a plurality of hard disk drives are installed in the server. Accordingly, the above problem can be coped with in such a way that, when a hard disk drive storing an OS therein has become inoperative, the OS is loaded from another hard disk drive. In such a case, however, the OS needs to be stored also in the other hard disk drive beforehand.

The above method in which the OS is prestored in a plurality of hard disk drives is effective when the primary hard disk drive has become completely inoperative. This can be achieved by including a program in the BIOS which, when the OS cannot be read out from the predetermined hard disk drive, causes the OS to be read out from the next hard disk drive.

However, the actual failure of the hard disk drive may often involve the situation where stored information cannot be completely read out though the hard disk drive is not completely inoperative. In this situation, the loading operation for the OS performed in accordance with the settings of the BIOS fails midway to favorably proceed, and is repeated many times.

In order to cope with such a situation, an operator needs to forcibly reset the failing hard disk drive from outside (by, for example, pressing a reset button), and to boot the system by employing a starter program stored in a CD-ROM or the like. The rebooting operation, which requires the intervention of the operator, is unsuitable for the rapid resumption of the system in the case where servers are distributed. Also, the rebooting operation requiring the intervention of the operator cannot be initiated if the operator or maintenance engineer is absent.

Additionally, the above described startup problem due to the failure of the hard disk drive can be coped with by adopting a RAID (Redundant Arrays of Inexpensive Disks) system. The RAID system is composed of a plurality of hard disk drives connected in parallel, all of which are operated just as a single disk storage device, to thereby increase data reading speed, or enhance durability against failures. With the RAID system, even when any of the hard disk drives has failed, its function is realized by another hard disk drive, so that the whole system is not adversely affected.

The RAID system, however, has a problem that a RAID adapter for performing the operation as stated above is required and is relatively expensive.

### SUMMARY OF THE INVENTION

It is an object of the present invention to provide an electronic apparatus which can boot a computer system reliably and automatically even when a storage device storing an OS therein has failed, and is inexpensive. It is another object of the present invention to provide a method for performing such booting. It is still another object of the present invention to provide a program for implementing the method.

According to the present invention, an OS is stored in each of a plurality of storage devices. Upon starting or loading the OS from the first storage device, counting is performed by a timer, and if the OS has not been normally loaded within a predetermined time period, the OS stored in the second storage device is loaded. Further, the loading process for the OS stored in the first storage device is forcibly stopped before the OS stored in the second storage device is loaded.

The present invention provides a method of booting an electronic apparatus comprising the steps of starting a timer and attempting to load an OS stored in a first storage device, first judging whether the OS stored in the first storage device has been normally loaded, second judging whether a count value of the timer has reached a predetermined value, and attempting to load an OS stored in a second storage device if the judgment at the first judging step is false and the judgment at the second judging step is true.

With the above method, even when the OS stored in the first storage device has not-been normally loaded for some reason, the OS stored in the second storage device is loaded after a predetermined time has elapsed.

The above method of booting an electronic apparatus may further comprise the step of resetting the timer if the judgment at the first judging step is true.

This operation is performed if the OS stored in the first storage device has been normally loaded, so that resetting the timer prevents the loading operation for the OS stored in the second storage device from being initiated. Resetting the timer means an operation of releasing the counting state of the timer and restoring the timer to a state previous to the initiation of the counting (the state in which the timer can start counting when so instructed). The reset timer does not perform a counting operation unless it is instructed to start counting.

The method of booting an electronic apparatus may further comprise the step of stopping loading the OS stored in the first storage device if the judgment at the first judgment step is false and the judgment at the second judgment step is true.

With this step, even when the loading of the OS stored in the first storage device is incomplete and is repeatedly retried, the incomplete loading is forcibly stopped after the predetermined time period has elapsed. Subsequently, a new attempt is made to load the OS stored in the second storage device, so that the apparatus can be reliably booted.

The invention described above can also be grasped as a system or a program. For the system, it is grasped as an electronic apparatus comprising first and second storage devices each of which stores an OS therein, a timer which counts a predetermined time period, and a third storage device storing a program in which procedures for executing the respective steps are defined. For the program, it is grasped as a program which causes a computer to execute the respective steps as procedures.

Examples of the OS are MS-DOS, Windows 95/98/2000, Windows NT, Mac OS, OS/2, and UNIX. MS-DOS, Windows and Windows NT are either registered trademarks or trademarks of Microsoft Corporation in the United States and/or other countries. Mac is a trademark of Apple Computer, Inc., registered in the United States and other countries. OS/2 is a trademark of International Business Machines Corporation in the United States, other countries, or both. UNIX is a registered trademark of The Open Group in the United States and other countries.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram showing an example of an electronic apparatus according to an embodiment of the present invention;

FIG. 2 is a flow chart for explaining an example of a method of booting an electronic apparatus according to an embodiment of the present invention;

FIG. 3 is a flow chart for explaining an example of a method of booting an electronic apparatus according to another embodiment of the present invention;

FIG. 4 is a flow chart for explaining an example of a method of booting an electronic apparatus according to still another embodiment of the present invention; and

FIG. 5 is a flow chart for explaining an example of a method of booting an electronic apparatus according to yet another embodiment of the present invention.

### PREFERRED EMBODIMENTS OF THE INVENTION

The preferred embodiments of the present invention will next be described in detail with reference to the drawings. It will be appreciated that the present invention can be implemented in various ways, and should not be limited to the embodiments described below. In the following, the same reference numerals are assigned to the same elements throughout the embodiments.

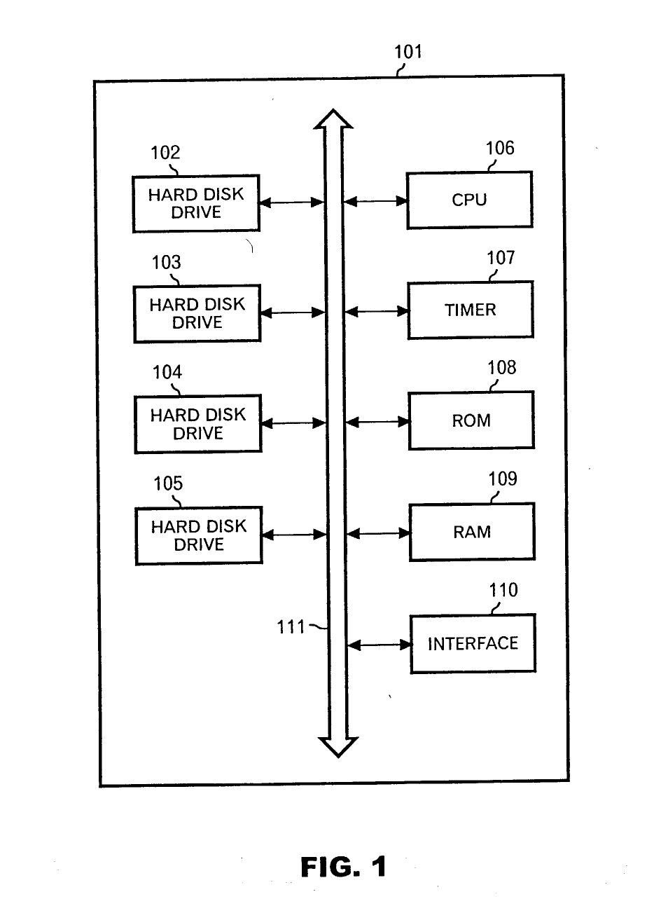

FIG. 1 is a block diagram showing an exemplary electronic apparatus according to one embodiment of the present invention. In this embodiment, the electronic apparatus is a server unit. Four hard disk drives 102-105 are installed in the server unit 101. Additionally, a CPU (central processing unit) 106, a timer 107, a ROM 108, a RAM (random access memory) 109 and an interface 110 are installed in the server unit 101. These devices are interconnected by a bus 111. Further, a power source, a cooling fan, etc., not shown, are also installed in the server unit 101.

The server unit 101 may be a file server, a print server, a communications server, a database server, a mail server, a Web server, or a multifunction server having functions of these servers. If the number of clients of the server is large, a plurality of server units may be used for distributed processing.

Each of the hard disk drives 102 and 103 stores an OS for booting the server unit 101. The hard disk drives 102-105 also stores information required for operating the server unit 101. Further, various information is written into and read out from the hard disk drives 102-105 during the operation of the server unit 101.

The CPU 106 controls the operations of the devices installed in the server unit 101 to perform server functions. The CPU 106 also controls an OS loading procedure to be explained later. The timer 107 has a function of counting a time period. Upon receiving a start counting instruction from the CPU 106 in accordance with a procedure to be explained later, the timer 107 begins to count the time elapsed. The CPU 106 reads the count value of the timer 107, and judges if it has reached a predetermined value. Alternatively, the timer 107 may notify the CPU 106 when the count value has reached the predetermined value. While the timer 107 is a hardware timer in this embodiment, it may be a software timer.

A BIOS is stored in the ROM 108. The BIOS stored in the ROM 108 includes a program for loading the OS in accordance with a procedure to be explained later. The RAM 109 temporarily stores information to be processed during the operation of the server unit 101. The interface 110 has a function necessary for exchanging information between the server unit 101 and a network not shown. The server unit 101 is connected to the network through the interface 110.

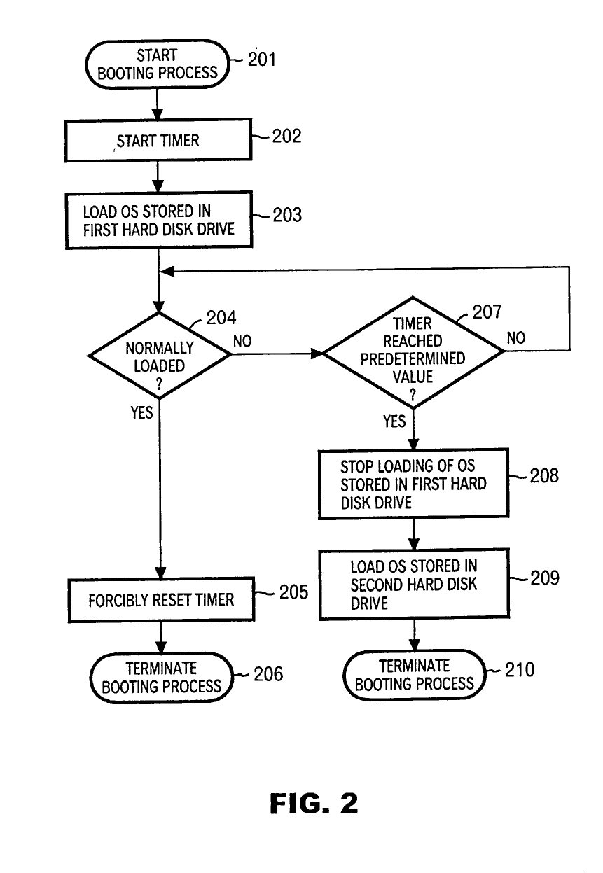

An example of the booting procedure for the server unit 101 will be described below. FIG. 2 is a flow chart for explaining an example of a method of booting an electronic apparatus according to the embodiment of the present invention. The example of the booting procedure for the server unit 101 will be described with reference to FIG. 2.

The booting procedure shown in FIG. 2 is executed in accordance with a program included in the BIOS stored in the ROM 108. Each step of the procedure is controlled and executed by the CPU 106.

First, a booting process is started (step 201). The booting process may be started when a predetermined time has been reached, a start switch provided in the server unit 101 has been operated, or the server unit 101 has become inoperable for some reason.

Then, the timer 107 is started (step 202), and it begins to count an elapsed time since its start.

After the timer 107 is started (step 202), an attempt is made to load the OS stored in the first hard disk drive 102 (step 203). The loading state of the OS is judged at step 204. If the judgment at step 204 is true, the timer 107 is forcibly reset (step 205). That is, if it is judged at step 204 that the OS stored in the first hard disk drive 102 has been normally loaded, the counting of the timer 107 is forcibly reset at step 205. The reset timer 107 is restored to a state which it had before the start of the counting. Note that the timer 107, once reset, does not start counting unless the start counting instruction is issued again. After the timer 107 is forcibly reset, the booting process is terminated (step 206).

If the judgment at step 204 is false, that is, if it is judged at step 204 that the OS stored in the first hard disk drive 102 has not been normally loaded, the routine proceeds to step 207. At step 207, it is judged whether the count value of the timer 107, that is, the time elapsed since the start of counting, has reached a predetermined value. The predetermined value which has been set beforehand should be of a longer time than that necessary for loading the OS. For example, if it takes 20 seconds to load the OS, the predetermined value is set to 25 seconds. If the judgment at step 207 is false, that is, if the OS has not been normally loaded and the timer 107 has not reached the predetermined value, the routine returns to step 204. This return path is provided because the OS might be normally loaded before the timer 107 reaches the predetermined value.

If the judgment at step 207 is true, the loading of the OS stored in the first hard disk drive 102 is stopped (step 208). That is, if the OS stored in the first hard disk drive 102 has not been normally loaded and the timer 107 has reached the predetermined value, the loading of the OS stored in the first hard disk drive 102 is forcibly stopped. At that time, it is possible that the loading of the OS stored in the first hard disk drive 102 has already been stopped for some reason, but step 208 is executed regardless thereof, which causes no substantial change in the booting process.

Then, the OS stored in the second hard disk drive 103 is loaded (step 209). After the loading of the OS stored in the second hard disk drive 103, the booting process is terminated (step 210).

In this embodiment, even if the OS stored in the first hard disk drive 102 has not been normally loaded for some reason, the loading of the OS stored in the second hard disk drive 103 is automatically executed by referring to the count value of the timer 107. Also, the loading of the OS stored in the first hard disk drive 102 is forcibly stopped when the predetermined time has elapsed, by utilizing the counting operation of the timer 107. Therefore, even if the loading of the OS stored in the first hard disk drive 102 is incomplete, the OS stored in the second hard disk drive 103 is loaded reliably.

In this embodiment, even if a hard disk drive storing an OS has failed, the OS is reliably loaded from another hard disk drive automatically. This embodiment can be implemented at low cost because only a BIOS program for executing the above procedure and a timer device are additionally required. The BIOS program for executing the above procedure may be prepared without so much labor and cost. Also, the timer device having the above function may be prepared at low cost.

In this embodiment, even if any trouble is involved in the loading of the OS, an operator or maintenance engineer need not do any action. Accordingly, it is possible to provide an automated server system for which maintenance work is reduced.

In this embodiment, steps 202 and 203 may be executed in reverse order. That is, the OS stored in the first hard disk drive may be loaded first, and then the timer may be started. Alternatively, steps 202 and 203 may be executed at the same time.

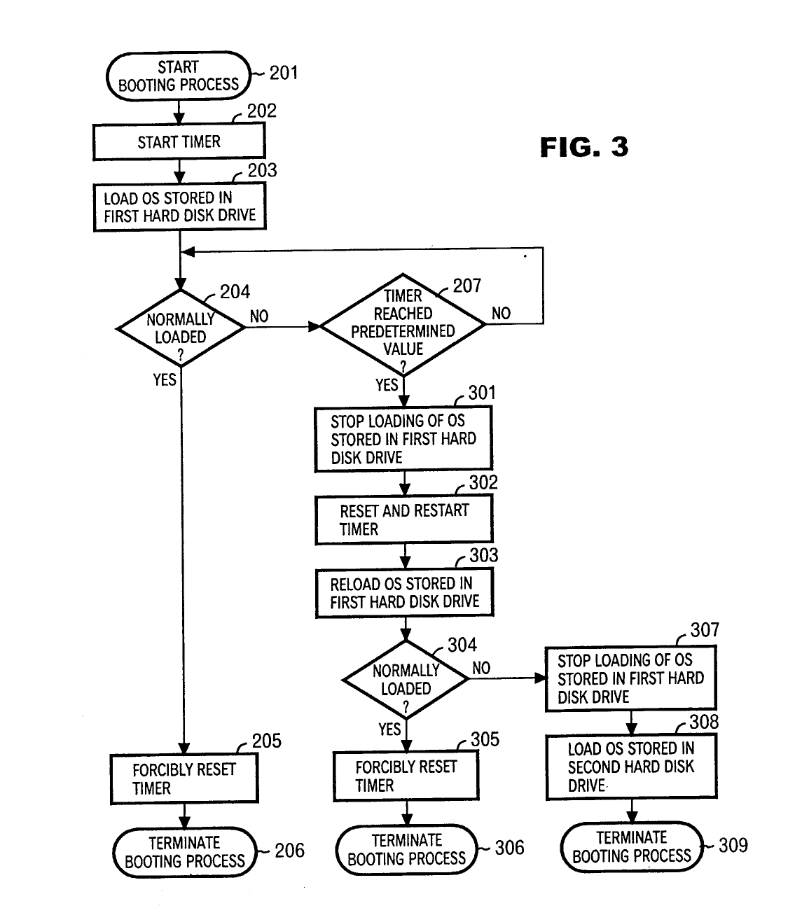

FIG. 3 is a flow chart for explaining an example of a method of booting an electronic apparatus according to an embodiment of the present invention. This embodiment is a modification to Embodiment 1. More specifically, this embodiment employs a procedure for rebooting the apparatus when the booting operation by the first hard disk drive has not been normally effected in the operating procedure of Embodiment 1.

In the following, steps to which the same reference numerals as in FIG. 2 are assigned are identical to those in Embodiment 1, respectively. First, a booting process is started (step 201), and the timer 107 is started counting (step 202). Then, the loading of the OS stored in the first hard disk drive 102 is started (step 203), and it is judged whether the OS stored in the first hard disk drive 102 has been normally loaded (step 204). If the judgment at step 204 is true, that is, if it is judged at step 204 that the OS stored in the first hard disk drive 102 has been normally loaded, the counting operation of the timer 107 is forcibly reset (step 205). Thereafter, the booting process is terminated (step 206).

If the judgment at step 204 is false, that is, if it is judged at step 204 that the OS stored in the first hard disk drive 102 has not been normally loaded, it is then judged whether the count value of the timer 107 has reached a predetermined value (step 207). If the judgment at step 207 is false, the routine returns to step 204. On the other hand, if the judgment at step 207 is true, the loading of the OS stored in the first hard disk drive 102 is forcibly stopped (step 301). Then, the timer 107 is reset and restarted (step 302). Further, the OS stored in the first hard disk drive 102 is reloaded (step 303). Then, it is judged again if the OS stored in the first hard disk drive 102 has been normally loaded (step 304). If the judgment at step 304 is true, that is, if it is judged at step 304 that the reloading of the OS stored in the first hard disk drive 102 has been normally effected, the counting operation of the timer 107 is forcibly reset (step 305). Thereafter, the booting process is terminated (step 306).

If the judgment at step 304 is false, that is, if the reloading of the OS stored n the first hard disk drive 102 has not been normally effected, the loading of the OS stored in the first hard disk drive 102 is forcibly stopped (step 307).

After step 307, an attempt is made to load the OS stored in the second hard disk drive 103 (step 308). After the OS stored in the second hard disk drive 103 has been loaded, the booting process is terminated (step 309).

In this embodiment, the OS stored in the first hard disk drive 102 is reloaded when its first loading has not been normally effected. Even when the OS has not been normally loaded from the hard disk drive, reloading is sometimes possible. This embodiment is effective in such a case.

In this embodiment, the-above reloading procedure may be used for the loading procedure of the OS stored in the second hard disk drive 103.

In this embodiment, steps 302 and 303 may be executed in reverse order. Alternatively, steps 302 and 303 may be simultaneously executed.

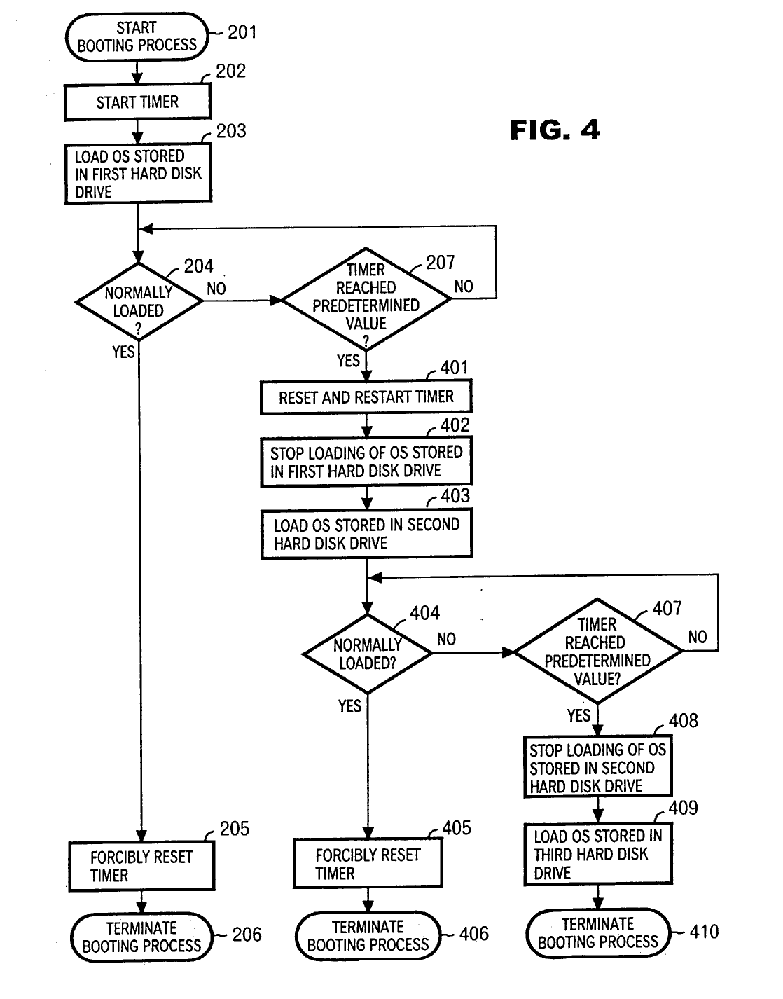

FIG. 4 is a flow chart for explaining an example of a method of booting an electronic apparatus according to an embodiment of the present invention. This embodiment is a modification to Embodiment 1. More specifically, in this embodiment, the OS is prestored, not only in the first hard disk drive 102 and the second hard disk drive 103, but also in the third hard disk drive 104. According to this embodiment, if the loading of the OS stored in the first hard disk drive 102 has not been normally effected, the OS stored in the second hard disk drive 103 is loaded. Further, if the loading of the OS stored in the second hard disk drive 103 has not been normally effected, the OS stored in the third hard disk drive 104 is loaded.

In the following, steps to which the same reference numerals as in FIG. 2 are assigned are identical to those in Embodiment 1, respectively. First, a booting process is started (step 201), and the timer 107 is started counting (step 202). Then, an attempt is made to load the OS stored in the first hard disk drive 102 (step 203). It is then judged whether the loading of the OS stored in the first hard disk drive 102 has been normally effected (step 204). If the judgment at step 204 is true, the counting operation of the timer 107 is forcibly reset (step 205). Thereafter, the booting process is terminated (step 206).

If the judgment at step 204 is false, it is judged whether the count value of the timer 107 has reached a predetermined value (step 207). If the judgment at step 207 is false, the routine returns to step 204. On the other hand, if the judgment at step 207 is true, the timer 107 is reset and restarted (step 401). Further, the loading of the OS stored in the first hard disk drive 102 is stopped (step 402). It is possible that the OS stored in the first hard disk drive 102 is not loaded at this point of time (the loading process has already been stopped), but the execution of step 402 in such a case causes no change in the booting procedure.

After the loading of the OS stored in the first hard disk drive 102 is stopped at step 402, an attempt is made to load the OS stored in the second hard disk drive 103 (step 403). Then, it is judged whether the loading of the OS stored in the second hard disk drive 103 has been normally effected (step 404).

If the judgment at step 404 is true, the counting operation of the timer 107 is forcibly reset (step 405). Thereafter, the booting process is terminated (step 406).

If the judgment at step 404 is false, it is judged whether the count value of the timer 107 has reached a predetermined value (step 407). If the judgment at step 407 is false, the routine returns to step 404. On the other hand, if the judgment at step 407 is true, the loading of the OS stored in the second hard disk drive 103 is stopped (step 408), and an attempt is made to load the OS stored in the third hard disk drive 104 (step 409). After the OS stored in the third hard disk drive 104 is normally loaded, the booting process is terminated (step 410).

According to this embodiment, three hard disk drives each storing the OS therein are prepared. When it is judged that the OS cannot be loaded from the first hard disk drive 102, the loading process of the OS from the first hard disk drive 102 is forcibly terminated, and the OS is loaded from the second hard disk drive 103. Further, when it is judged that the OS cannot be loaded from the second hard disk drive 103, the loading process of the OS from the second hard disk drive 103 is forcibly terminated, and the OS is loaded from the third hard disk drive 104.

According to this embodiment, when the loading of the OS from the first hard disk drive 102 and the second hard disk drive 103 cannot be normally effected within a predetermined time period, the loading process is forcibly terminated. Accordingly, even when the booting process is unfinished, loading from the next hard disk drive is automatically performed. Further, according to this embodiment, since up to three attempts are made to load the OS from the respective hard disk drives, a situation where the OS cannot be loaded due to the failure of a hard disk drive can be avoided at a high probability.

In this embodiment, steps 401 and 402 may be executed in reverse order. Alternatively, steps 401 and 402 may be simultaneously executed. Also, step 401 may be executed after step 403. That is, steps 402, 403 and 401 may be executed in this order.

Although up to three attempts can be made to load the OS in this embodiment, the number of attempts may be four or five. Further, this embodiment may be combined with the reloading process explained in Embodiment 2.

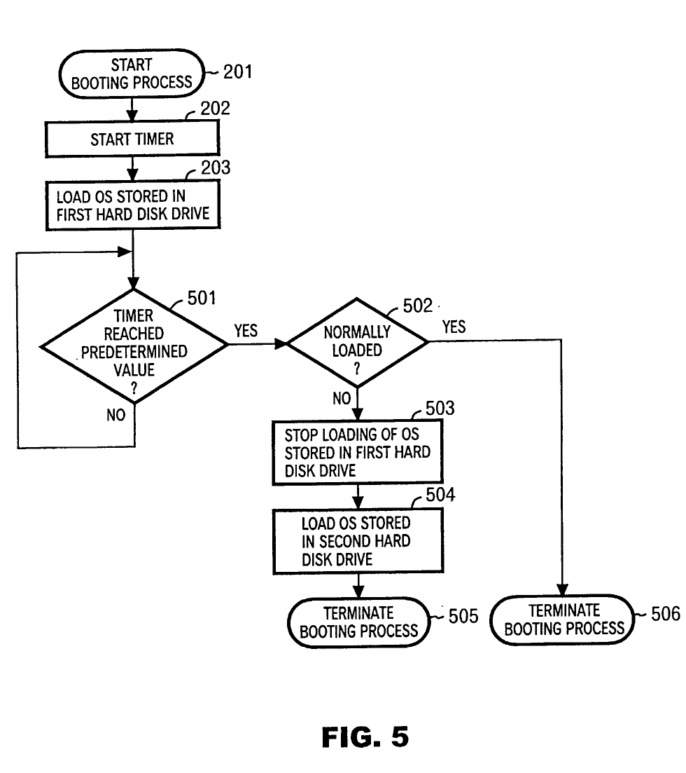

FIG. 5 is a flow chart for explaining an example of a method of booting an electronic apparatus according to an embodiment of the present invention. In this embodiment, it is first judged whether the count value of the timer has reached a predetermined value, and then it is judged whether the loading of the OS has been normally effected.

In FIG. 5, steps 201 through 203 are the same as in Embodiment 1 and, therefore, will not be described again. In this embodiment, after an attempt is made to load the OS stored in the first hard disk drive 102 at 203, it is judged whether the counting by the timer 107 has reached the predetermined value (step 501). If the judgment at step 501 is true, it is judged whether the loading of the OS stored in the first hard disk drive 102 has been normally effected (step 502). If the judgment at step 502 is false, the loading of the OS stored in the first hard disk drive 102 is stopped (step 503). Then, an attempt is made to load the OS stored in the second hard disk drive 103 (step 504). After the OS stored in the second hard disk drive is loaded, the booting process is terminated (step 505). If the judgment at step 502 is true, the booting process is terminated (step 506).

Thus, the present invention can execute the first judgment step for judging whether the loading of the OS stored in the first storage device has been normally effected, and the second judgment step for judging whether the count value of the timer has reached the predetermined value in this order, which is reverse to the order in the other embodiments.

While the present invention has been concretely described in conjunction with the embodiments, it will be appreciated that the present invention is not limited to the foregoing embodiments, and can be modified without departing from the spirit thereof. For example, the present invention is applicable to any electronic equipment which requires loading or activation of some program, such as personal computers, workstations, etc., in addition to the server. The electronic equipment may be communications equipment, measurement equipment, control equipment, precision equipment, electric household appliances, etc., each of which is controlled by a computer.

Also, in the foregoing embodiments, the OS was stored in a hard disk drive. However, the OS may be stored in an optical disk such as CD or DVD, magneto-optical disk, semiconductor memory, magnetic tape, or any other medium or device capable of storing electronic information therein. It is also possible to combine different sorts of storage devices for storing the OS. For example, it is possible to employ a combination of storage devices in which a hard disk drive is used as a first storage device while an optical disk is used as a second storage device. Also, a storage device other than the ROM may be used for storing the BIOS. Further, in the above embodiments, each of the loading procedures for the OS shown in FIGS. 2-5 was included in the BIOS. However, the loading procedure for the OS may be included in a different program than the BIOS. Alternatively, the loading procedure may be an independent program.

Also, while FIG. 1 illustrated an example in which a single CPU was employed as a device for controlling the various steps, a plurality of CPUs may share in the function of controlling the steps. Alternatively, a device which takes charge of the control of a particular step or steps may be employed.

It should be understood that the present invention may be implemented as a program product for use with a data storage system or computer system. Programs defining the functions of the present invention can be delivered to a data storage system or computer system via a variety of signal-bearing media, which include, without limitation, non-writable storage media (e.g. CD-ROM), writable storage media (e.g. a floppy diskette, hard disk drive, read/write CD-ROM, optical media), and communication media, such as computer and telephone networks including Ethernet. It should be understood, therefore, that such signal-bearing media, when carrying or encoding computer readable instructions that direct the method functions of the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A method of booting a data processing system, said method comprising:
storing an operating system on a first storage device and a copy of said operating system on a second storage device;
said data processing system initiating loading of said operating system from said first storage device for execution;
determining if said loading of said operating system from said first storage device has successfully completed before a pre-determined period of time has elapsed; and
if said loading of said operating system from said first storage device has not successfully completed before said pre-determined period of time has elapsed, then:
terminating said loading of said operating system from said first storage device, and
loading said copy of said operating system from said second storage device for execution by said data processing system.

2. The method of claim 1, wherein said data processing system is a server on a computer network.

3. The method of claim 1, wherein said storage devices are disk drive devices.

4. The method of claim 1, wherein said pre-determined period of time is measured by a timer controlled by said data processing system.

5. The method of claim 1, wherein said loading of said copy of said operating system from said second storage device is controlled by a Basic Input/Output System (BIOS) of said data processing system.

6. The method of claim 1, wherein if said operating system is not successfully loaded from said second storage device within a pre-determined amount of time, then loading another copy of said operating system from a third storage device for execution by said data processing system.

7. The method of claim 1, wherein if said loading of said operating system from said first storage device has not successfully completed before said pre-determined period of time has elapsed, then re-initiating said loading of said operating system from said first storage device before attempting said loading of said copy of said operating system from said second storage device.

8. A data processing system comprising:
a first storage device;
a second storage device;
means for storing an operating system on said first storage device and a copy of said operating system on said second storage device;
means for said data processing system initiating loading of said operating system from said first storage device for execution;
means for determining if said loading of said operating system from said first storage device has successfully completed before a pre-determined period of time has elapsed; and
means for, if said loading of said operating system from said first storage device has not successfully completed before said pre-determined period of time has elapsed, then:
terminating said loading of said operating system from said first storage device, and
loading said copy of said operating system from said second storage device for execution by said data processing system.

9. The data processing system of claim 8, wherein said data processing system is a server on a computer network.

10. The data processing system of claim 8, wherein said storage devices are disk drive devices.

11. The data processing system of claim 8, wherein said pre-determined period of time is measured by a timer controlled by said data processing system.

12. The data processing system of claim 8, wherein said loading of said copy of said operating system from said second storage device is controlled by a Basic Input/Output System (BIOS) of said data processing system.

13. The data processing system of claim 8, wherein if said operating system is not successfully loaded from said second storage device within a pre-determined amount of time, then said data processing system further comprises means for loading another copy of said operating system from a third storage device for execution by said data processing system.

14. The data processing system of claim 8, wherein if said loading of said operating system from said first storage device has not successfully completed before said predetermined period of time has elapsed, then said data processing system further comprises means for re-initiating said loading of said operating system from said first storage device before attempting said loading of said copy of said operating system from said second storage device.

15. A computer program product within a computer usable medium for loading an operating system from a storage device for execution on a data processing system, said computer program product comprising:
instructions for storing an operating system on a first storage device and a copy of said operating system on a second storage device;
instructions for said data processing system initiating loading of said operating system from said first storage device for execution;
instructions for determining if said loading of said operating system from said first storage device has successfully completed before a pre-determined period of time has elapsed; and
instructions for, if said loading of said operating system from said first storage device has not successfully completed before said pre-determined period of time has elapsed, then:
terminating said loading of said operating system from said first storage device, and
loading said copy of said operating system from said second storage device for execution by said data processing system.

16. The computer program product of claim 15, wherein said data processing system is a server on a computer network.

17. The computer program product of claim 15, wherein said storage devices are disk drive devices.

18. The computer program product of claim 15, wherein said instructions for said loading of said copy of said operating system from said second storage device are located in a Basic Input/Output System (BIOS) of said data processing system.

19. The computer program product of claim 15, wherein if said operating system is not successfully loaded from said second storage device within a pre-determined amount of time, then said computer program product further comprises instructions for loading another copy of said operating system from a third storage device for execution by said data processing system.

20. The computer program product of claim 15, wherein if said loading of said operating system from said first storage device has not successfully completed before said pre-determined period of time has elapsed, then said computer program product further comprises instructions for re-initiating said loading of said operating system from said first storage device before attempting said loading of said copy of said operating system from said second storage device.
